(19) United States
(12) Patent Application Publication
(10) Pub. No.: US 2003/0125906 A1
(43) Pub. Date: Jul. 3, 2003

(54) Method and apparatus for assessing the impact of individual parts of a gas turbine component on the overall thermal performance of a gas turbine

(76) Inventor: Paul A. Guaglardi, Clifton Park, NY (US)

Correspondence Address: NIXON & VANDERHYE P.C., 1100 North Glebe Road, 8th Floor, Arlington, VA, 22201, US

(21) Appl. No.: 10/028,936

(22) Filed: Dec. 28, 2001

(51) Int. Cl. G06F 11/30; G06F 15/00; G21C 17/00

(52) U.S. Cl. 702/182

(57) ABSTRACT

A method of determining performance impact of a gas turbine component on overall thermal performance of a gas turbine. The method includes obtaining measured physical condition data for a select gas turbine component part. The measured physical condition data is compared with a predetermined reference value for the select gas turbine component part to determine a deviation of the measured physical condition data with respect to the predetermined reference value. The impact of the deviation on the overall thermal performance of the gas turbine is subsequently determined.

### FIELD OF THE INVENTION

This invention relates to gas turbines more particularly, to a method and apparatus for determining the impact of gas turbine engine hardware on the overall thermal performance of the gas turbine engine or a complete combined cycle arrangement.

### BACKGROUND OF THE INVENTION

FIG. 1 schematically illustrates a typical combined cycle power plant 100. The power plant 300 includes, such exemplary components/subsystems as a steam turbine 102, condenser 104, a cooling tower 106, a gas turbine 200, and a heat recovery steam generator or HRSG 110. Exhaust gases from the gas turbine 200 are supplied to the HRSG 110 for recovering waste heat. Each component/subsystem of the power plant includes various parts, generally referred to herein as “component parts.”

During early phases of power plant design, an engineer designs a thermal model of each major component of the power plant. For example, a thermal model of each of a gas turbine, steam turbine, heat recovery steam generator (HRSG), condenser, etc., may be designed. In addition to designing a thermal model for each of the individual components, an overall thermal model combining the individual thermal models may also be designed. This overall thermal model captures the interaction between the individual component models. It may also be used as a basis for determining thermal performance guarantees at a reference set of boundary conditions.

Similar to the combined cycle power plant, a gas turbine engine component also includes various component parts. These component parts may change their condition over the engine life. Typically, once the engine has left the factory, the condition of an engine component part changes from factory conditions. Accordingly, the thermal performance of the gas turbine engine changes over the life of the engine from its factory condition. In most cases, the thermal performance of the gas turbine engine degrades over time.

Power plant performance may be demonstrated by a performance test. As boundary conditions during test performance are not likely to be identical to reference boundary conditions, (which may be, for example, factory installed condition) the test results may have to be corrected to be a true representation of the plant performance at the reference boundary conditions.

In one approach, the results of the tested conditions are corrected by using a set of curves generated by executing the overall plant thermal model and varying the boundary conditions one at a time. In the event of a performance shortfall, this approach may provide fairly accurate values for corrected power plant performance. However, this approach provides no indication as to which component(s) of the power plant is responsible for the performance shortfall.

Other approaches used tools for determining the overall thermal performance of gas turbine components. However, no tool has been developed to identify the performance impact of a single part from “within” a component of a gas turbine. For example, previously, although a user was able to determine that there was a problem in the compressor section of the gas turbine, the user was unable to identify which part of the identified compressor is likely causing the problem.

Thus, it would be desirable to overcome the above-identified problems.

### SUMMARY OF THE INVENTION

Accordingly, the present invention relates to methods and systems for determining a gas turbine component part that is likely deteriorating and impacting the thermal performance of the gas turbine engine. The deterioration of a gas turbine component part is quantified to determine whether or not to undertake efforts to regain lost performance of the gas turbine engine.

Specifically, measurements are made to determine the physical condition of various parts of a gas turbine component. Measurements are particularly made on gas turbine components considered relevant to the overall thermal performance of the gas turbine engine. Measurements may be made manually on some component parts of the gas turbine engine after disassembling a component. Measurements may be automatically made on other component parts using a data acquisition computer system. Measured data is then stored into a computer system having application programs loaded in a processor therein. For example, Excel® spreadsheet application program from Microsoft Corporation, may be used to receive and compare the measured data of a select gas turbine component part with reference data representative of new and clean condition of the select component part. Deviation of the measured data from the reference data is determined and correlated, through the use of “trade-factors”, to determine the impact of deviation on the overall thermal performance of the gas turbine engine.

In another embodiment, the system and method of the present invention are used to determine the impact of a deteriorating gas turbine component part on the overall thermal performance of a combined cycle power-plant. The method of determining the performance impact of various power plant components is similar to the above method described with respect to the gas turbine engine.

One exemplary aspect of this invention involves a method of determining performance impact of a gas turbine component on overall thermal performance of a gas turbine. The method includes obtaining measured physical condition data for a select gas turbine component part, comparing the measured physical condition data with a predetermined reference value for the select gas turbine component part. The deviation of the measured physical condition data with respect to the predetermined reference value is determined.

The impact of the deviation on the overall thermal performance of the gas turbine is determined, preferably, by correlating a deviation value with a corresponding predetermined overall thermal performance effect factor. The step of obtaining measured physical condition data includes measuring the physical condition of the select gas turbine component to obtain the measured physical condition data, and storing the measured physical condition data in a memory. A process is preferably used to compare the measured physical condition data with a predetermined reference value. The method of determining the performance impact further includes displaying an indication of the impact on the overall thermal performance of the gas turbine.

Another exemplary aspect of this invention involves an apparatus for determining performance impact of a gas turbine component part on overall thermal performance of the gas turbine. The apparatus includes means for obtaining measured physical condition data for select gas turbine component part; means for comparing the measured physical condition data of the select gas turbine component part with a corresponding predetermined reference value; means for determining a deviation of the measured physical condition data with respect to the predetermined reference value; and means for determining an impact of the deviation on the overall thermal performance of the gas turbine.

In still another exemplary aspect of this invention involves a computer program product comprising a computer useable medium having computer program logic stored thereon for enabling a processor in a computer system to process data, the computer program product when executed by the processor performing the steps of comparing measured physical condition data of a select gas turbine component part with a corresponding predetermined reference value; determining a deviation of the measured physical condition data with respect to the predetermined reference value; and determining an impact of the deviation on the overall thermal performance of the gas turbine.

In a further exemplary aspect, this invention provides in a combined cycle power plant having a plurality of components, each component having a plurality of component parts, a method for determining performance impact of a component part on overall thermal performance of the power-plant, the method comprising obtaining measured physical condition data for a select component part; comparing the measured physical condition data with a corresponding predetermined reference value; determining a deviation of the measured physical condition data with respect to the predetermined reference value; and determining an impact of the deviation on the overall thermal performance of the power plant.

### BRIEF DESCRIPTION OF THE DRAWINGS

FIG. 1 is a schematic view of a typical combined cycle power plant;

FIG. 2 is a schematic view of a typical gas turbine;

FIG. 3 illustrates various exemplary component parts of the gas turbine component shown in FIG. 2;

FIG. 4 shows various exemplary parts of a heat recovery steam generator component shown in FIG. 3;

FIG. 5 shows a computer system for determining the impact of individual parts of a gas turbine component on the overall thermal performance of the gas turbine in accordance with an exemplary embodiment of the present invention; and

FIG. 6 is an exemplary table stored in the computer system shown in FIG. 5, the table used for determining the impact of a physical condition of a gas turbine component part on the overall thermal performance of the gas turbine;

FIG. 7 shows an exemplary data acquisition computer system for automatically measuring a physical condition of select parts of a gas turbine component;

FIG. 8 is an exemplary flow schematic illustrating the process steps involved in determining the impact of individual parts of the gas turbine component on the overall thermal performance of the gas turbine shown in FIG. 1;

FIG. 9 illustrates an exemplary tool for manually measuring a physical condition of a gas turbine component part in accordance with an exemplary embodiment of the present invention; and

FIG. 10 shows exemplary details of the processor illustrated in FIG. 5 of the present invention.

The benefits of the present invention will become apparent to those skilled in the art from the following detailed description, wherein a preferred embodiment of the invention is shown and described, simply by way of illustration of the best mode contemplated of carrying out the invention.

### DETAILED DESCRIPTION OF THE INVENTION

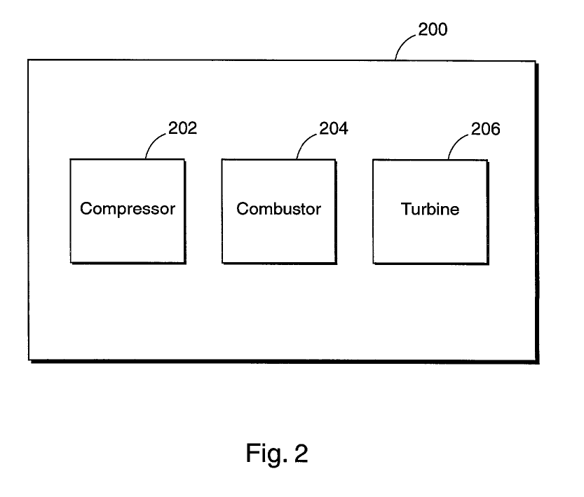

FIG. 2 is a schematic illustration of a typical gas turbine system. The gas turbine system 200 typically includes a compressor 202 for compressing a working fluid, such as air. The compressed air is injected into a combustor 204 that heats the fluid, and the fluid is then expanded through a turbine unit 206.

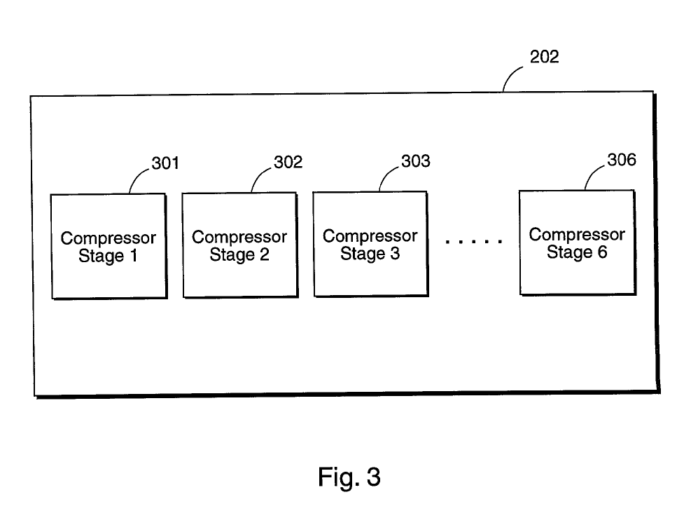

Each of the compressor 202, combustor 204, and turbine 106 components include various component parts. For example, compressor 202 typically includes several compressor stages to achieve desired pressure. In this regard, FIG. 3 shows an example compressor 202 having compressor stages one through six identified by numerals 301 through 306. It will be appreciated that the number of stages shown in FIG. 3 is merely exemplary to identify typical parts of a compressor.

A compressor is a series of rotor blades and stator blades. The rotating blades add energy to the flow and increase the pressure. When tip clearances on either the rotors or the stators are excessive, the efficiency of the compressor decreases. Clearance of compressor blades is measured relative to the compressor casing. Typically, the measurements are taken with the gas turbine apart, i.e., the top half of the machine is preferably removed so that the clearances may be obtained for all of the stages. For example, clearances may be measured with a “feeler” gage 900 as shown in FIG. 9. Feeler gages are strips of metal of different thicknesses “h” that one can add up to see the full width of a gap or clearance. Finally, for each stage, the clearance is divided by the height of the blade so as to obtain the clearance over height numbers.

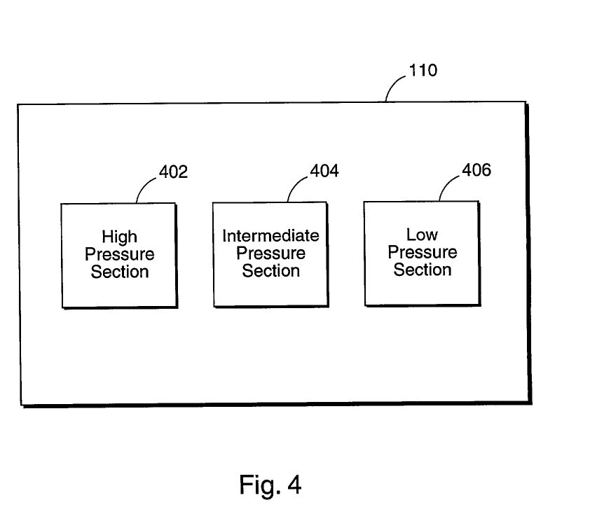

Each power-plant component includes various component parts. For example, the HRSG 110 typically includes a high pressure section 402, intermediate pressure section 404, and a low pressure section 406 as illustrated in FIG. 4. Similar to measurements made on gas turbine component parts, measurements may be made on such parts as the high pressure section 402, intermediate section 404, or low pressure section 406 of the HRSG 110 to determine the impact of deterioration of these parts on the overall performance of the combined cycle power-plant 100.

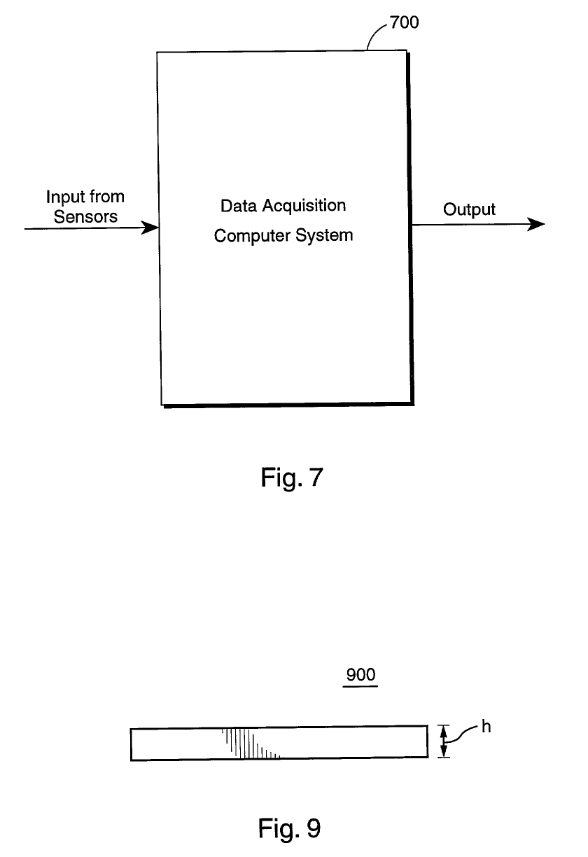

Having described measurement of compressor blade clearance, it is to be noted that other measurements may be made using a data acquisition computer system 700 (FIG. 7) which is capable of receiving and processing data from one or more sensors strategically placed on various gas turbine component parts to obtain measurements on such parts. The effect of the ratio of the clearance to blade height, as noted above, on the overall thermal performance of the gas turbine engine is determined.

A partial list of exemplary measurements taken on the gas turbine that may have an affect on the performance of the gas turbine include:

a) compressor tip clearances, measurements related to rotor and stator;

b) compressor surface roughness of the rotor and stators;

c) seal clearances in the compressor section;

d) extraction Flow orifice diameters;

e) rubs in the compressor casing and/or rubs from the stators on the shaft of a compressor;

f) turbine nozzle throat areas and surface roughnesses; and

g) turbine “bucket” tip clearances and surface roughnesses.

All of the measurements as identified above are preferably measured with standard precision equipment. For example, surface roughnesses of a component part are measured in a direction of gas flow through the gas turbine. Measurements are taken in line with measurements depicted on drawings for the gas turbine so that measured data can be compared to the original numbers/reference values.

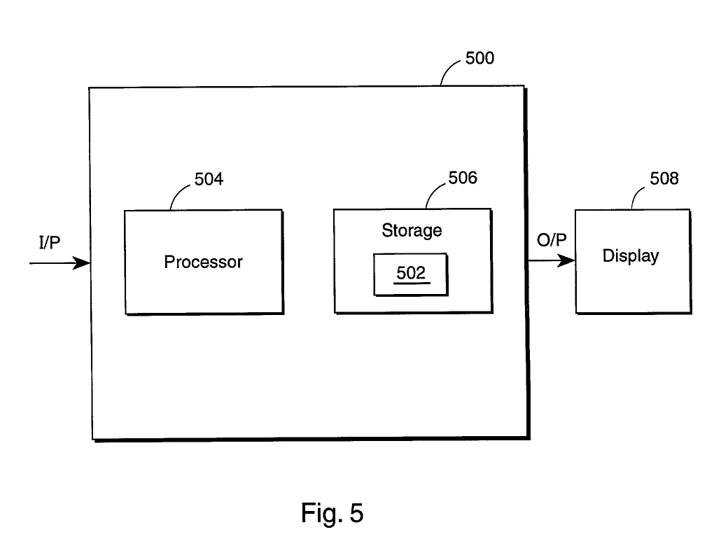

Data obtained from the measurements is input into a computer system 500 (FIG. 5) where it is compared with predetermined reference values, using a software application program loaded therein, to determine the deviation of the measured data over predetermined reference values. The deviation values are quantified to determine their effect on the overall thermal performance of the power-plant by correlating the deviation values to corresponding thermal performance values stored in a storage device 506 of the computer system 500 (FIG. 5). A database 502 may also be stored in the storage device 506 for organizing data stored therein.

As mentioned above, FIG. 5 shows a computer system 500 for determining the impact of deterioration of various component parts of a gas turbine component on the overall thermal performance of the gas turbine 100. The computer system 500 further includes a processor 504 for performing data processing and executing various functions of the computer system 500. For example, measured physical conditions of various parts of a gas turbine component are input into the computer system 500 where the received data is processed to determine the effect of measured deviation of a component part on the overall thermal performance of the gas turbine. Data related to new/clean condition (i.e., reference data) of various component parts of a gas turbine component is also stored in the storage device 506 of the computer system 500.

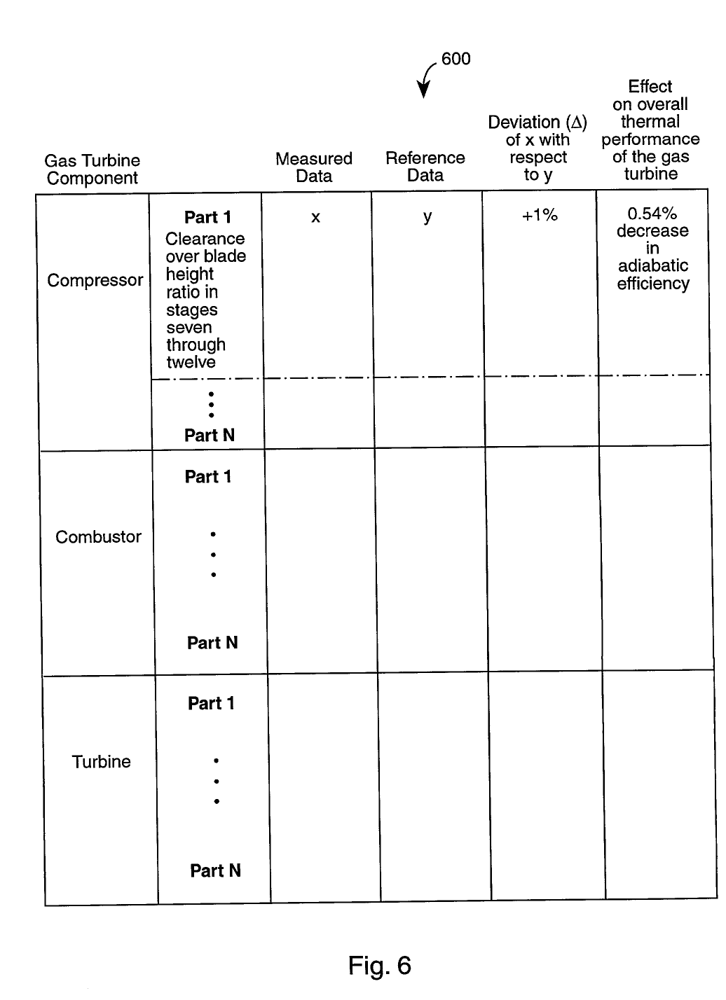

The database 502 is preferably loaded with application programs for receiving input data and determining the impact of various component parts on the overall thermal performance of the gas turbine. The processor 504 is used to compare data related to a measured condition of various parts of a gas turbine component with reference data stored in the storage device. From the comparison step, deviation of the measured data over reference data is determined. For each component part, the impact of deviation of measured data from reference data is determined apriori and stored in the storage device 506 in the form of a table as shown in FIG. 6.

For given sets of deviation values, variations in the thermal efficiency of the gas turbine for each deviation value set are theoretically/empirically determined and stored as a table in the storage device 506. The measured deviation values for a component part are compared in the processor with the theoretical deviation values (reference data) identified in the table 600, and the effect of deviation, on the overall thermal performance of the gas turbine, is empirically determined from the table 600 and a recoverability signal is generated. The recoverability signal indicates whether or not any loss in the overall thermal performance of the gas turbine engine or power plant may be recovered by making repairs to a deteriorating component part that is identified to cause the loss in thermal performance. For example, if the measured data for clearance over blade height ratio in stages seven through twelve of compressor 102 is “x”, and the ideal reference data is “y”, then the deviation (Δ) of measured data “x” with respect to “y” may be determined using theoretical derivations. For example, in an exemplary correlation, a one percent increase in the clearance over blade height ratio in stages one through six of a compressor may lead to a 0.54% decrease in the overall adiabatic efficiency of the compressor.

Additionally, the increase in clearance may lead to a 0.2% decrease in compressor flow. Since both flow and efficiency of a compressor are direct contributors to gas turbine thermal performance, knowing the current physical condition of a part of a gas turbine component enables one to estimate the impact of a deteriorating component part on the overall performance of the gas turbine. “Theoretical Derivations” indicate correlations developed from basic physics and applied to the condition so as to pick up an effect. For example, for surface roughness, a correlation needed to be developed in order to be able to assess a change in performance with a corresponding change in surface roughness. This may be performed through the use of the “friction factor” and flow through a pipe.

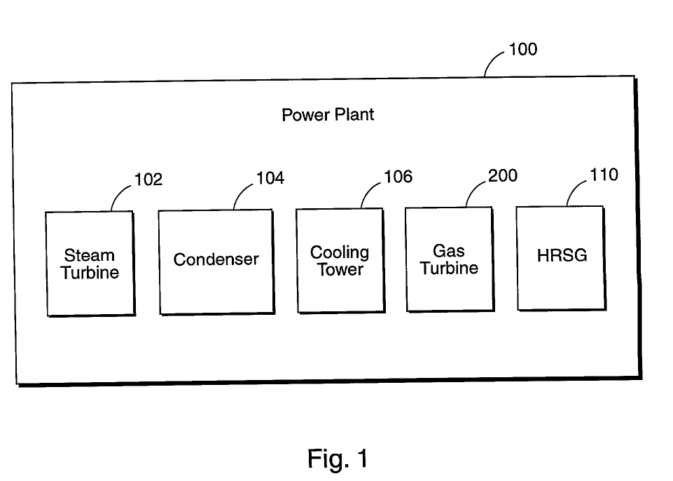

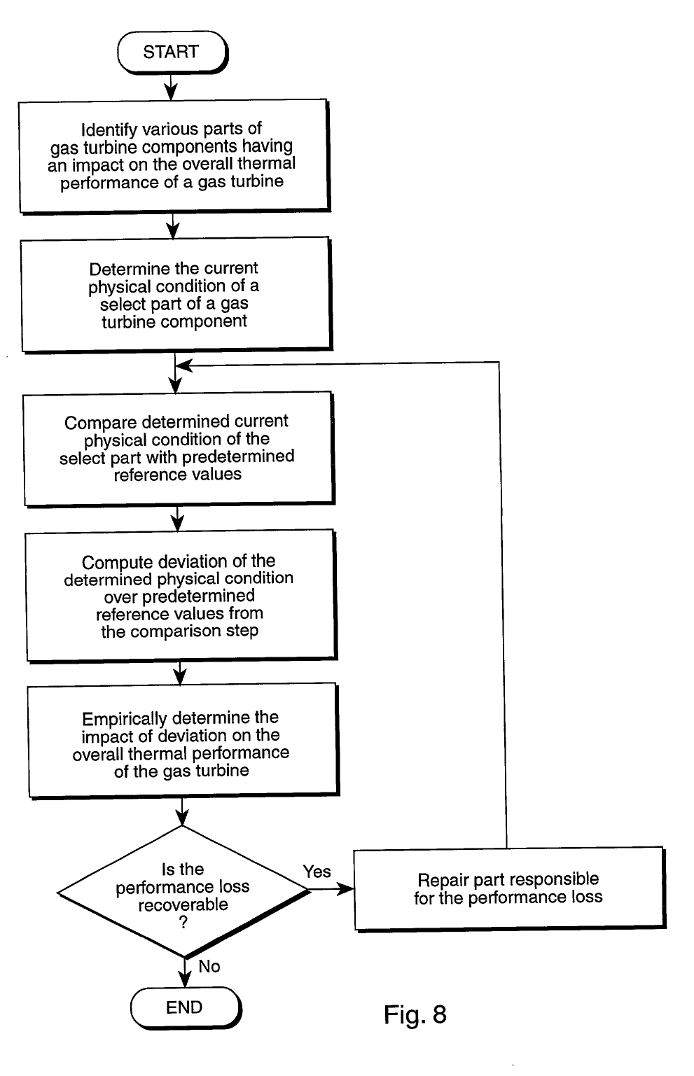

FIG. 8 is an exemplary flow schematic illustrating process steps involved in determining the impact of deterioration of various parts of a gas turbine component on the overall thermal performance of the gas turbine identified in FIG. 1. The various process steps identified in the flow schematic are described above and are therefore not repeated. Upon making a determination that the performance loss resulting from a deteriorating part of a gas turbine component is not recoverable, then further investment and efforts to repair such part are not undertaken. On the other hand, if it is determined that the performance loss of the gas turbine is recoverable, then a deteriorating part may be repaired to improve the overall thermal performance of the gas turbine.

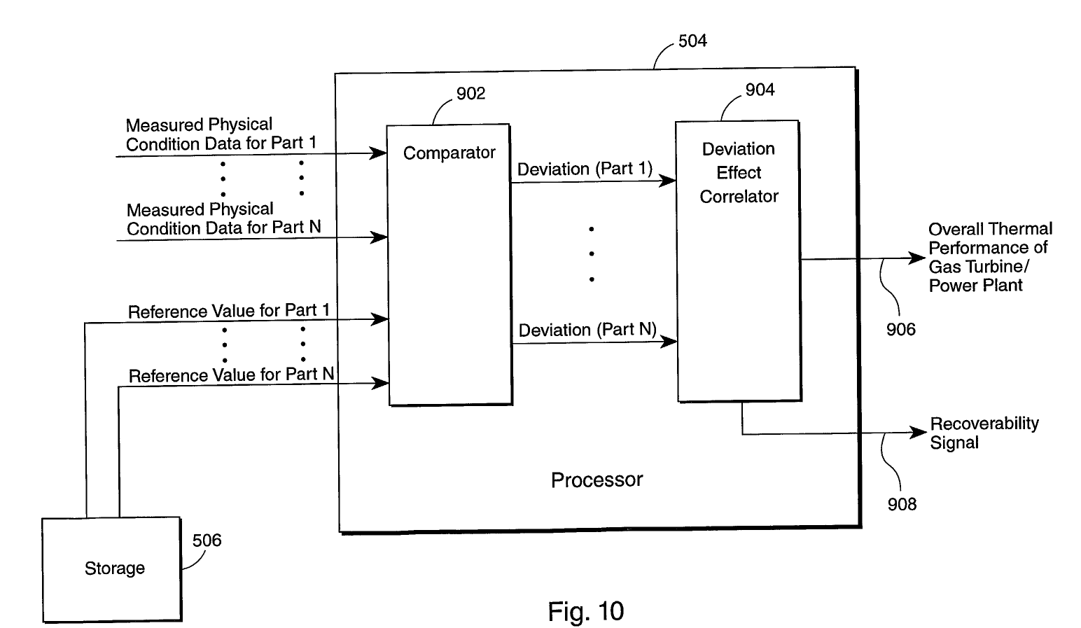

FIG. 10 shows exemplary details of the processor 504 depicted in FIG. 5. The processor 504 includes a comparator 902 and a deviation effect correlator 904. The comparator 902 receives and compares measured physical condition data of a component part and a corresponding predetermined reference value from the storage device 506 (FIG. 5). A deviation signal is produced from the comparison step. The deviation signal is then correlated, in a deviation effect correlator 904, with predetermined parameters, an exemplary template of which is shown in FIG. 6, to generate a signal 906 indicative of the impact of deviation on the overall thermal performance of a gas turbine engine or a power plant. The deviation effect correlator 904 may also be used to generate a recoverability signal 908 which is indicative of whether or not the overall loss in thermal performance of the gas turbine or power plant, caused by a deteriorating gas turbine component part or a power plant component part, may be recovered by undertaking repairs to such a component part.

While the invention has been described in connection with what is presently considered to be the most practical and preferred embodiment, it will be understood that the invention is not to be limited to the disclosed embodiment, but on the contrary, is intended to cover various modifications and equivalent arrangements included within the spirit and scope of the appended claims.

What is claimed is:

1. A method of determining performance impact of a gas turbine component on overall thermal performance of a gas turbine, the method comprising:
(a) obtaining measured physical condition data for a select gas turbine component part;
(b) comparing the measured physical condition data with a predetermined reference value for the select gas turbine component part;
(c) determining a deviation of the measured physical condition data with respect to the predetermined reference value; and
(d) determining an impact of the deviation on the overall thermal performance of the gas turbine.

2. The method as in claim 1, wherein step (d) is determined by correlating a deviation value with a corresponding predetermined overall thermal performance effect factor.

3. The method as in claim 1, wherein step (a) further comprises:
measuring the physical condition of the select gas turbine component to obtain the measured physical condition data;
storing the measured physical condition data in a memory.

4. The method as in claim 1, wherein step (b) is performed using a processor.

5. The method as in claim 1, further comprising:
(e) displaying an indication of the impact on the overall thermal performance of the gas turbine.

6. An apparatus for determining performance impact of a gas turbine component part on overall thermal performance of the gas turbine, comprising:
means for obtaining measured physical condition data for a select gas turbine component part;
means for comparing the measured physical condition data of the select gas turbine component part with a corresponding predetermined reference value;
means for determining a deviation of the measured physical condition data with respect to the predetermined reference value; and
means for determining an impact of the deviation on the overall thermal performance of the gas turbine.

7. The apparatus as in claim 6, wherein an impact of the deviation is determined by correlating a deviation value with a corresponding predetermined performance effect factor.

8. The apparatus as in claim 6, further comprising:
a memory for storing the measured physical condition data of the select gas turbine component part.

9. The apparatus as in claim 6, further comprising:
means for displaying an indication of the impact on the overall performance of the gas turbine.

10. The apparatus as in claim 6, wherein the determining means uses empirically developed trade factors and theoretically derived relationships to determine the impact of deviation.

11. A computer program product comprising a computer useable medium having computer program logic stored thereon for enabling a processor in a computer system to process data, said computer program product when executed by the processor performing the steps of:
(a) comparing measured physical condition data of a select gas turbine component part with a corresponding predetermined reference value;
(b) determining a deviation of the measured physical condition data with respect to the predetermined reference value; and
(c) determining an impact of the deviation on the overall thermal performance of the gas turbine.

12. In a combined cycle power plant having a plurality of components, each component having a plurality of component parts, a method for determining performance impact of a component part on overall thermal performance of the power-plant, the method comprising:
(a) obtaining measured physical condition data for a select component part;
(b) comparing the measured physical condition data with a corresponding predetermined reference value;
(c) determining a deviation of the measured physical condition data with respect to the predetermined reference value; and
(d) determining an impact of the deviation on the overall thermal performance of the power plant.

13. The method as in claim 12, wherein step (d) is determined by correlating the deviation value with a corresponding predetermined overall thermal performance effect factor.

14. The method as in claim 12, further comprising:
(e) displaying an indication of the impact on the overall thermal performance of the power plant.

15. A computer-based method for providing assistance to a user of an application program for assessing performance impact of a gas turbine component part on overall thermal performance of a gas turbine, the method comprising:
obtaining measured physical condition data of a select gas turbine component part;
using an application program to determine a deviation of the measured physical data with respect to a corresponding reference value; and
determining an impact of the deviation on the overall thermal performance of the gas turbine by correlating the deviation with a corresponding predetermined thermal performance effect factor.
